(19) United States
(12) Patent Application Publication
(10) Pub. No.: US 2006/0086212 A1
(43) Pub. Date: Apr. 27, 2006

(54) Adjustable wrench

(76) Inventor: Chih-Ching Hsieh, Feng Yuan City (TW)

Correspondence Address: TROXELL LAW OFFICE PLLC, SUITE 1404, 5205 LEESBURG PIKE, FALLS CHURCH, VA, 22041, US

(21) Appl. No.: 10/971,077

(22) Filed: Oct. 25, 2004

(51) Int. Cl. B25B 13/00; B25B 7/02

(52) U.S. Cl. 81/186; 81/165; 81/418

(57) ABSTRACT

An adjustable wrench including a handle and a fixed jaw and a movable jaw disposed at one end of the handle. Two opposite sides of the two jaws respectively have a clamping face. At least two types of tooth regions are formed on the clamping face of at least one of the jaws. The tooth regions include a fine-tooth region composed of multiple fine teeth near inner end of the jaw and a coarse-tooth region composed of multiple coarse teeth near outer end of the jaw. When wrenching a small-size worn nut, the fine teeth of the fine-tooth regions of the jaws serve to clamp the nut. When wrenching a large-size worn nut, the coarse teeth of the coarse-tooth regions of the jaws serve to engage the nut.

### BACKGROUND OF THE INVENTION

The present invention is related to a hand tool, and more particularly to an adjustable wrench in which the clamping faces of the jaws are formed with different tooth regions with different finenesses and patterns. A worn nut can be clamped by a most suitable tooth region and effectively wrenched by the wrench.

A conventional adjustable wrench has a fixed jaw and a movable jaw the position of which can be adjusted to change the width between the two jaws. Accordingly, the adjustable wrench can be applied to various nuts with different sizes.

A common nut is hexagonal and has six corners. When the nut is worn, the corners will become obtuse. Under such circumstance, the wrench tends to slip away when wrenching the nut. In order to enable the wrench to not only wrench a normal nut, but also wrench a worn nut, as shown in FIG. 1, the clamping faces of the two jaws 12, 14 of the conventional adjustable wrench are formed with multiple teeth 16 for biting the nut and enhancing clamping effect.

However, the teeth 16 of the jaws of the conventional adjustable wrench have unified dimension so that the adjustable wrench is not applicable to all kinds of worn nuts with different sizes. For example, in the case that the pitch between the teeth 16 is larger, when applied to a small-size worn nut, the number of the teeth in contact with the nut will be insufficient to effectively clamp the nut. Therefore, the wrench may still slip away from the nut. On the other hand, in the case that the pitch between the teeth 16 is smaller, when applied to a worn nut, the number of the teeth in contact with the nut can be increased, however, the too densely arranged teeth will contact with the sides of the nut as a plane. Therefore, the teeth can hardly effectively bite the worn nut. Moreover, when wrenching a large-size nut, the fine teeth 16 tend to break off.

Therefore, it is necessary to provide an adjustable wrench which is able to effectively wrench various worn nuts with different sizes.

### SUMMARY OF THE INVENTION

It is therefore a primary object of the present invention to provide an adjustable wrench in which the jaws are able to effectively clamp different sizes of normal nuts and worn nuts.

According to the above object, the adjustable wrench includes a handle and a fixed jaw and a movable jaw disposed at one end of the handle. Different types of tooth regions are formed on a clamping face of at least one of the jaws. A worn-nut can be clamped by a most suitable tooth region so that the wrench can effectively wrench the worn nut.

The present invention can be best understood through the following description and accompanying drawings wherein:

### BRIEF DESCRIPTION OF THE DRAWINGS

FIG. 1 is a perspective view of a conventional adjustable wrench;

FIG. 2 is front view of a preferred embodiment of the adjustable wrench of the present invention;

FIGS. 3 and 4 are enlarged view according to FIG. 2;

FIGS. 5 and 6 show that the adjustable wrench of the present invention is used to clamp and wrench a small-size nut;

FIGS. 7 and 8 show that the adjustable wrench of the present invention is used to clamp and wrench a middle-size nut;

FIGS. 9 and 10 show that the adjustable wrench of the present invention is used to clamp and wrench a large-size nut;

FIG. 11 shows another embodiment of the adjustable wrench of the present invention;

FIG. 12 shows still another embodiment of the adjustable wrench of the present invention; and

FIG. 13 shows still another embodiment of the adjustable wrench of the present invention.

### DETAILED DESCRIPTION OF THE PREFERRED EMBODIMENTS

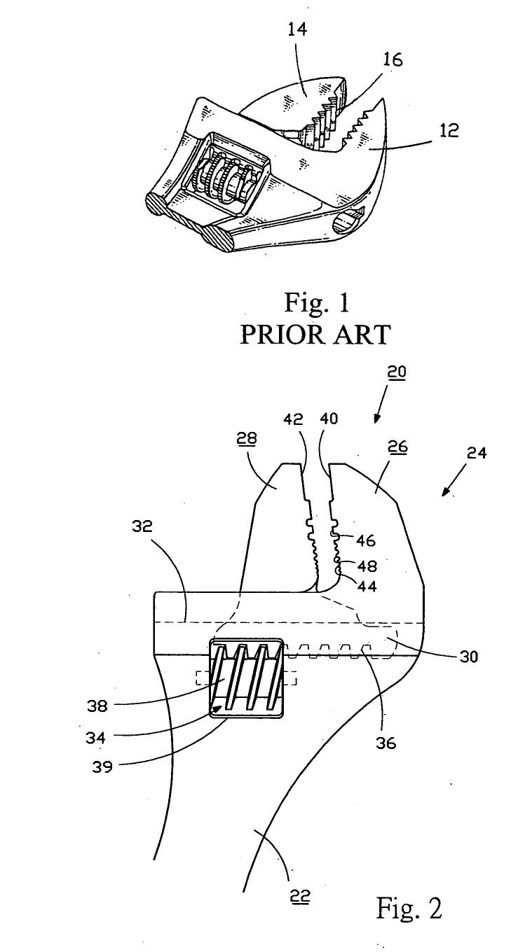

Please refer to FIG. 2. According to a preferred embodiment, the adjustable wrench 20 of the present invention has a handle 22 and a head section 24 at one end of the handle 22. The head section has a fixed jaw 26 on one side and is formed with a transverse guide channel 32. A movable jaw 28 has a transverse guide bar 30 at bottom end, which is transversely displaceably disposed in the guide channel 32 of the head section 24. A controlling member 34 includes multiple teeth 36 formed under bottom face of the guide bar 30 and a thread rod 38. The thread rod 38 is pivotally connected in a cavity 39 of the handle and rotatably engaged with the teeth 36. When rotating the thread rod 38, the movable jaw 28 is driven to displace so as to change the distance between the two jaws 26, 28. Many other types of controlling members can be used to control the movable jaw so that the present invention is not limited to the controlling member as shown in FIG. 2.

The inner sides of the two jaws are respectively a clamping face 40, 42 in parallel to each other. The clamping faces have multiple teeth. In this embodiment, the teeth of each clamping face include three types of teeth, that is, multiple fine teeth 44 near inner end of the jaw, multiple coarse teeth 46 near outer end of the jaw and multiple middle teeth 48 positioned between the fine teeth and coarse teeth. These three types of teeth are continuously arranged on the clamping face.

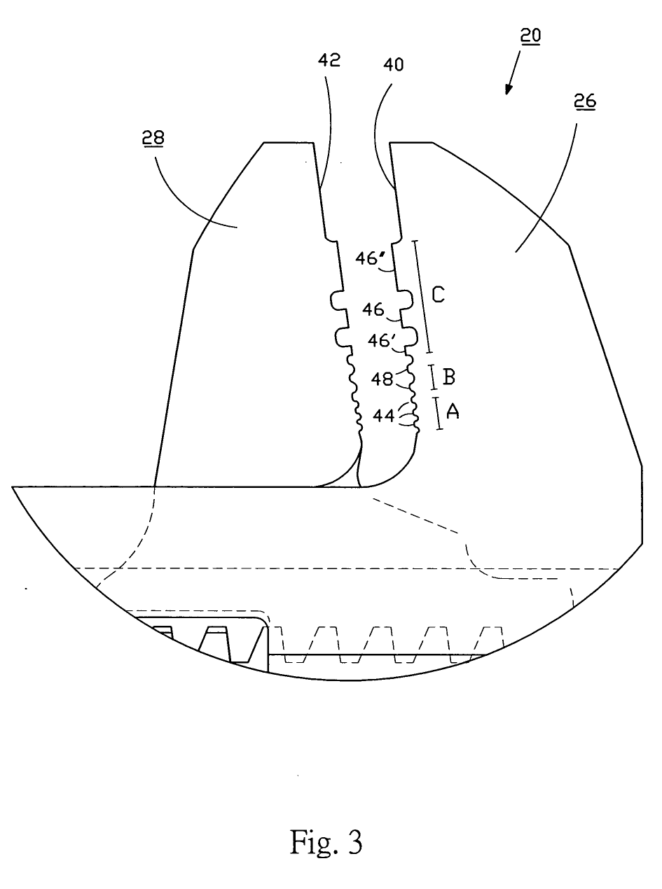

Referring to FIG. 3, in this embodiment, the width of the fine teeth 44 is smaller than that of the middle teeth 48, while the width of the middle teeth 48 is smaller than that of the coarse teeth 46. In addition, the fine teeth 44 and middle teeth 48 have round tips, while the coarse teeth 46 are rectangular teeth.

In this embodiment, there are three fine teeth 44, two middle teeth 48 and three coarse teeth 46. The fine teeth 44 have equal width. The middle teeth 48 also have equal width, while the three coarse teeth 46 have different widths. The innermost coarse tooth 46′ has a smallest width, while the outermost coarse tooth 46″ has a largest width.

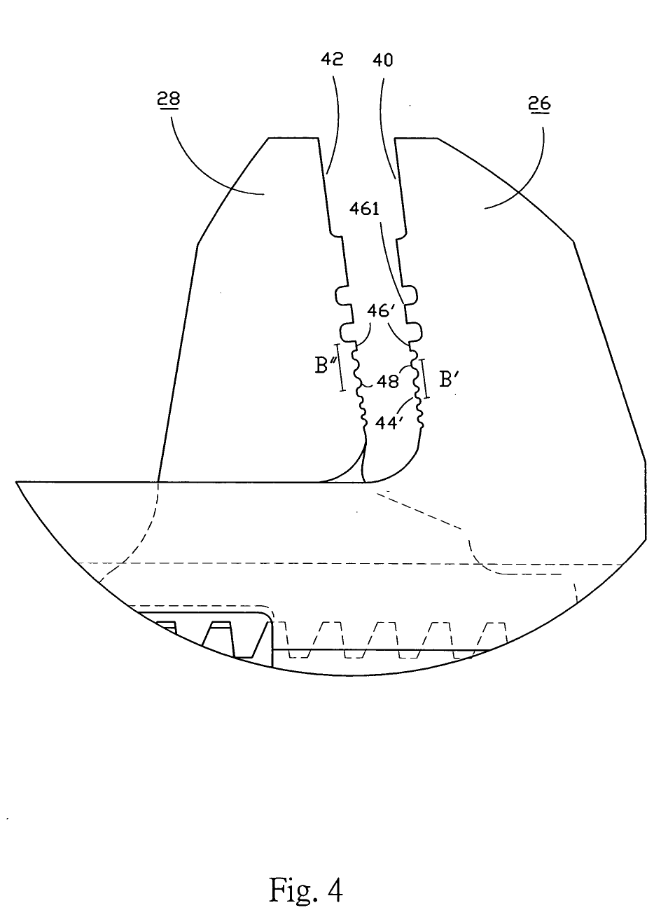

The fine teeth 44 form a fine-tooth region A for clamping small-size nut. The middle teeth 48 form a middle-tooth region B and the coarse teeth 46 form a coarse-tooth region C. Due to the teeth 44, 48, 46 are continuously arranged on the clamping faces 40, 42 of the jaws, the ranges of the tooth regions A, B, C are expanded. For example, referring to FIG. 4, the outermost fine tooth 44′ is immediately adjacent to the middle teeth 48. When clamping a middle-size nut, the fine tooth 44′ and the two middle teeth 48 form an expanded middle-tooth region B′ for contacting with the side of the middle-size nut. Similarly, the innermost coarse tooth 46′ and the two middle teeth 48 form another expanded middle-tooth region B″ for clamping the middle-size nut. The outermost fine tooth 44′ and the innermost coarse tooth 46′ also define therebetween another expanded middle-tooth region.

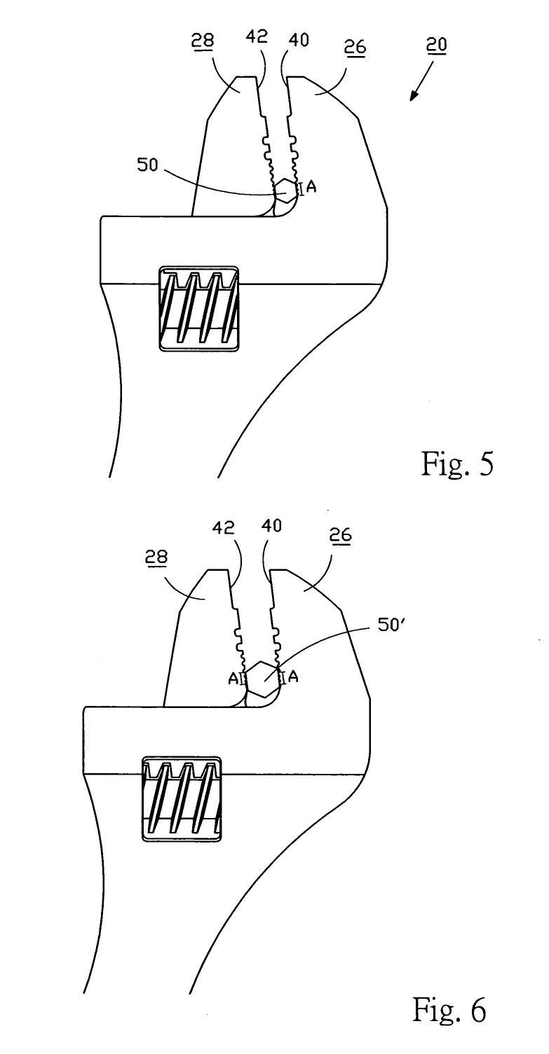

FIGS. 5 and 6 show that the wrench 20 is used to clamp and wrench a small-size nut. No matter whether the nut is worn, the fine-tooth regions A of the clamping faces 40, 42 of the jaws 26, 28 clamp two sides of the nut 50, 50′.

When clamping a worn small-size nut, the pitch between the fine teeth 44 is small so that more teeth contact with and abut against the sides of the worn nut so that the worn small-size nut can be effectively wrenched.

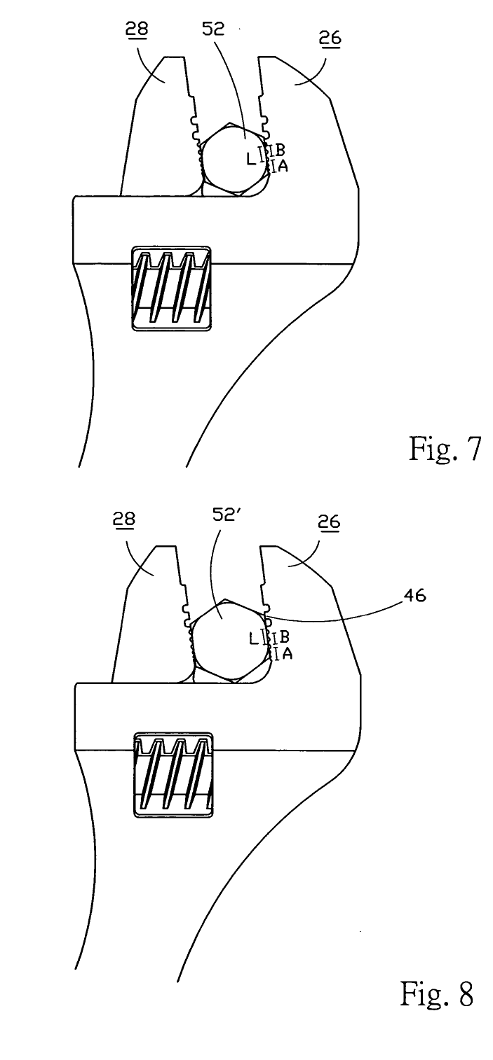

FIGS. 7 and 8 show that the wrench 20 is used to clamp and wrench a middle-size nut 52, 52′. The right hexagonal shape means a normal nut, while the round profile means a worn nut. When clamping and wrenching a normal nut 52 as shown in FIG. 7, the fine-tooth region A and the middle-tooth region B contact with the sides of the nut. When clamping and wrenching a normal nut 52′ as shown in FIG. 8, in addition to the fine-tooth region A and the middle-tooth region B in contact with the sides of the nut, one or two coarse tooth 46 also contact with the sides of the nut. In the case that the corners of the nut 52 or 52′ are worn to form the round profiles of FIGS. 7 and 8, the sides of the nut are shortened. At this time, the middle-tooth regions B of the jaws 26, 28 contact with the sides L of the worn nut to effectively wrench the nut.

When clamping and wrenching the worn middle-size nut, the fineness and pitch of the middle teeth 48 are just adapted to the sides of the nut. Therefore, a proper number of teeth contact with the sides L of the worn nut to provide sufficient engaging force. Accordingly, the clamping faces can exert sufficient torque onto the worn nut for wrenching the same. In addition, when contacting with the middle-size nut, the middle teeth has sufficient strength without breaking off.

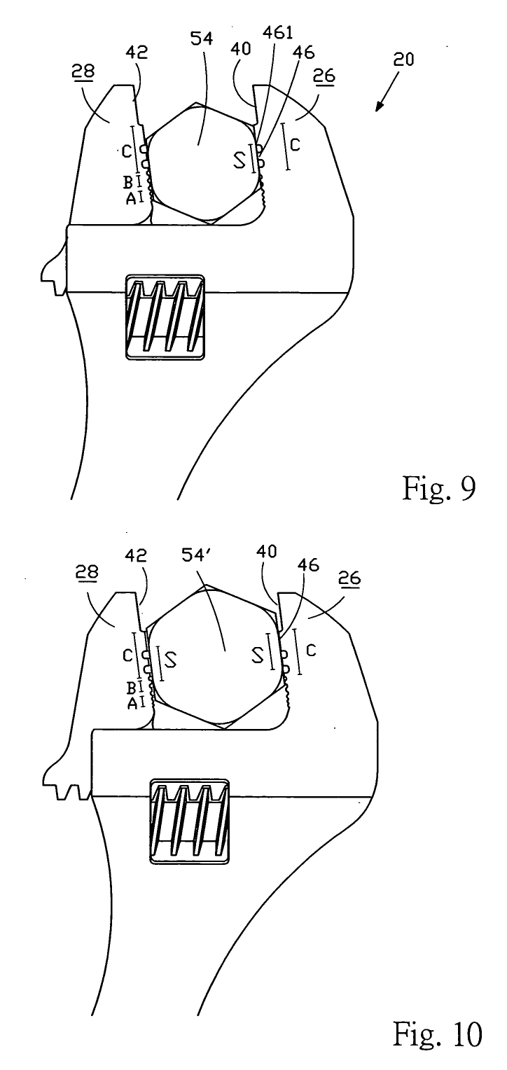

FIGS. 9 and 10 show that the wrench 20 is used to clamp and wrench a large-size nut. When clamping and wrenching a normal nut 54, 54′, the three tooth regions A, B, C or the tooth regions B, C contact with the sides of the nut. In the case that the nut is worn, the sides of the nut will be shortened so that the contact areas between the clamping faces and the nut are reduced. It can be known from FIGS. 9 and 10 that when clamping the worn nut, the coarse teeth 46 of the coarse-tooth regions C of the clamping faces 40, 42 contact with the sides S of the worn nut for wrenching the nut. When wrenching the nut, the acute angles 461 of the coarse teeth 46 as shown in FIG. 4 abut against the side of the nut. Multiple acute angles 461 of the clamping faces bite the worn sides S of the nut, whereby the jaws can apply sufficient engaging force to the sides S of the worn nut for effectively wrenching the same. The more outward the teeth of the clamping faces 40, 42 are, the greater the required torque is. Therefore, the outermost coarse teeth are made with largest width.

FIG. 11 shows another embodiment of the adjustable wrench of the present invention, in which the fine teeth 68, middle teeth 66 and coarse teeth 64 of the clamping face 62 of the jaw 60 have identical profile. For example, these teeth are all rectangular teeth, round teeth or sharp teeth having acute tips as shown in FIG. 11.

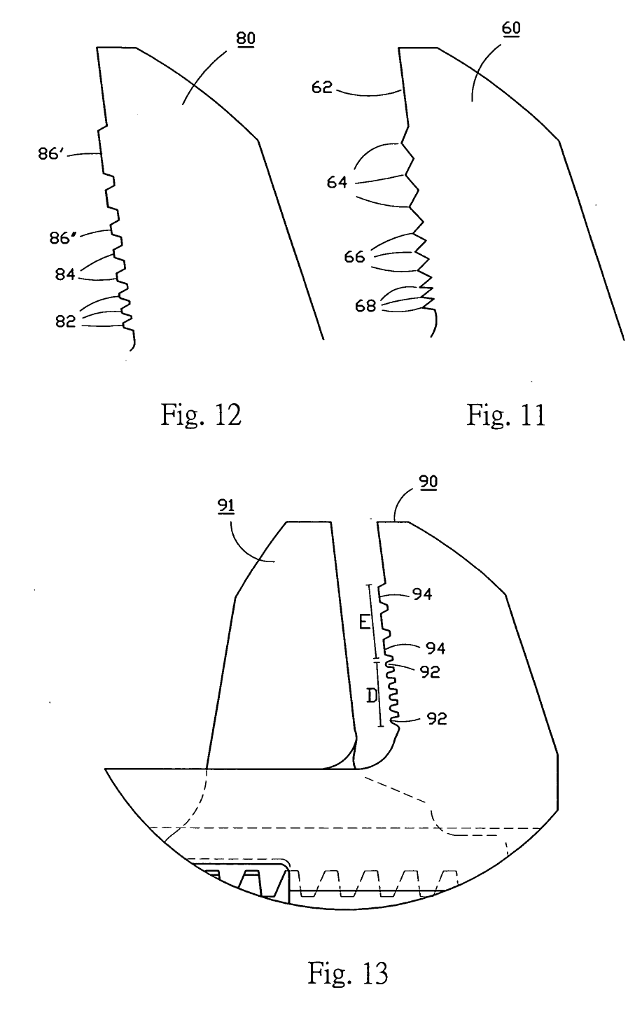

FIG. 12 shows still another embodiment of the adjustable wrench of the present invention, in which the fine teeth 82, middle teeth 84 and coarse teeth 86 of the jaw 80 also have identical profile. For example, these teeth all have a shape of a frustum as the teeth of a common gear. The outermost coarse tooth 86′ has a maximum tooth width, while the innermost coarse tooth 86″ has a minimum tooth width among the coarse teeth. The frustum-shaped teeth and rectangular teeth both have a plane and two acute angles on two sides of the plane.

FIG. 13 shows still another embodiment of the adjustable wrench of the present invention, in which only one jaw 90 is formed with multiple teeth, while the other jaw 91 has a plane clamping face. The teeth can be divided into two types of tooth regions, that is, a fine-tooth region D formed of multiple fine teeth 92 near inner end of the jaw and a coarse-tooth region E formed of multiple coarse teeth 94 near outer end of the jaw. The two types of tooth regions serve to clamp various sizes of worn nuts. The teeth 92, 94 can have any of the profiles of the above embodiments.

In the present invention, the jaws of the wrench are formed with tooth regions with different finenesses. The nut can be clamped by the most suitable tooth regions, whereby the jaws can apply sufficient torque to the nut for effectively wrenching the same. Accordingly, even if the nut is worn off, the jaws can still firmly bite the worn sides of the nut. Therefore, the wrench can be used to effectively wrench various sizes of worn nuts. Moreover, the teeth of the jaws have sufficient strength so that when wrenching the nut, the teeth will not break off.

The above embodiments are only used to illustrate the present invention, not intended to limit the scope thereof. Many modifications of the above embodiments can be made without departing from the spirit of the present invention.

What is claimed is:

1. An adjustable wrench comprising:
a handle;
a fixed jaw and a movable jaw disposed at one end of the handle, the movable jaw being displaceable relative to the fixed jaw to change the width between the two jaws, two opposite sides of the two jaws respectively having a clamping face;
a controlling member disposed between the movable jaw and the handle for controlling the movable jaw to displace; and
multiple teeth formed on the clamping face of at least one of the jaws, said adjustable wrench being characterized in that at least two types of tooth regions are formed on the clamping face of the jaw, the tooth regions including a fine-tooth region composed of multiple fine teeth near inner end of the jaw and a coarse-tooth region composed of multiple coarse teeth near outer end of the jaw.

2. The adjustable wrench as claimed in claim 1, wherein the teeth with different finenesses have identical profile.

3. The adjustable wrench as claimed in claim 1, wherein the fine and coarse teeth have different profiles.

4. The adjustable wrench as claimed in claim 1, wherein an outermost tooth of the teeth has a largest tooth width.

5. The adjustable wrench as claimed in claim 1, wherein among the coarse teeth, an innermost coarse tooth has a smallest tooth width, while an outermost coarse teeth has a largest tooth width.

6. The adjustable wrench as claimed in claim 1, wherein at least each coarse tooth has a plane top and two acute angles on two sides of the plane top.

7. The adjustable wrench as claimed in claim 1, wherein each tooth has an acute top.

8. The adjustable wrench as claimed in claim 1, wherein the top of each coarse tooth has at least one acute angle and the top of each fine tooth is round.

9. The adjustable wrench as claimed in claim 1, wherein the clamping faces of the two jaws are both formed with the tooth regions.

10. An adjustable wrench comprising:
a handle;
a fixed jaw and a movable jaw disposed at one end of the handle, the movable jaw being displaceable relative to the fixed jaw to change the width between the two jaws, two opposite sides of the two jaws respectively having a clamping face;
a controlling member disposed between the movable jaw and the handle for controlling the movable jaw to displace; and
multiple teeth formed on the clamping face of at least one of the jaws, said adjustable wrench being characterized in that at least three types of tooth regions are formed on the clamping face of the jaw, the tooth regions including a fine-tooth region composed of multiple fine teeth near inner end of the jaw, a coarse-tooth region composed of multiple coarse teeth near outer end of the jaw and a middle-tooth region composed of at least one middle-size tooth positioned between the fine-tooth region and the coarse-tooth region.

11. The adjustable wrench as claimed in claim 10, wherein the teeth with different finenesses have identical profile.

12. The adjustable wrench as claimed in claim 10, wherein the fine and coarse teeth have different profiles.

13. The adjustable wrench as claimed in claim 10, wherein the fine, middle and coarse teeth have different profiles.

14. The adjustable wrench as claimed in claim 10, wherein an outermost tooth of the teeth has a largest tooth width.

15. The adjustable wrench as claimed in claim 10, wherein among the coarse teeth, an innermost coarse tooth has a smallest tooth width, while an outermost coarse teeth has a largest tooth width.

16. The adjustable wrench as claimed in claim 10, wherein at least each coarse tooth has a plane top and two acute angles on two sides of the plane top.

17. The adjustable wrench as claimed in claim 10, wherein each tooth has an acute top.

18. The adjustable wrench as claimed in claim 10, wherein the top of each coarse tooth has at least one acute angle and the top of each fine tooth is round.

19. The adjustable wrench as claimed in claim 10, wherein the top of each coarse tooth has at least one acute angle and the top of each of the fine teeth and middle teeth is round.

20. The adjustable wrench as claimed in claim 10, wherein the clamping faces of the two jaws are both formed with the tooth regions.
